(19) United States
(12) Patent Application Publication
(10) Pub. No.: US 2024/0409718 A1
(43) Pub. Date: Dec. 12, 2024

(54) AEROSOL PROVISION DEVICE

(71) Applicant: NICOVENTURES TRADING LIMITED, London (GB)

(72) Inventors: Jonathan BURGESS, London (GB); Conor MCGRATH, London (GB)

(21) Appl. No.: 18/700,465

(22) PCT Filed: Oct. 11, 2022
(86) PCT No.: PCT/EP2022/078243

§ 371 Date: Apr. 11, 2024

(30) Foreign Application Priority Data
Oct. 11, 2021 (GB) 2114494.4

(51) Int. Cl. C08K 7/28; A24F 40/20; A24F 40/465; A24F 40/90; F16L 59/02

(52) U.S. Cl. CPC C08K 7/28; A24F 40/20; A24F 40/465; A24F 40/90; F16L 59/028; C08K 2201/005

(57) ABSTRACT

An aerosol provision device including one or more insulating members, wherein the one or more insulating members includes a polymeric composition which includes (i) a polymer and (ii) a filler having a thermal conductivity of about 0.20 W/mK or less. Also provided is an aerosol provision system having the aerosol provision device and an article including aerosol generating material.

### RELATED APPLICATIONS

The present application is a National Phase entry of PCT Application No. PCT/EP2022/078243 filed Oct. 11, 2022, which claims priority to GB Application No. 2114494.4 filed Oct. 11, 2021, each of which is hereby incorporated by reference in their entirety.

### TECHNICAL FIELD

The present invention relates to an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device comprising a polymeric composition which comprises (i) a polymer and (ii) a filler having a thermal conductivity of about 0.20 W/mK or less.

In embodiments, the thermal conductivity of the filler is less than the thermal conductivity of the polymer.

In embodiments, the polymer has a thermal conductivity of greater than about 0.20 W/mK, such as from about 0.25 W/mK to about 0.45 W/mK or from about 0.30 W/mK to about 0.40 W/mK.

In embodiments, the polymer is an elastomer, an amorphous thermoplastic polymer or a semi-crystalline thermoplastic.

In embodiments, the polymer is selected from the group consisting of polycarbonate (PC), polyethylenimine (PEI), acrylonitrile butadiene styrene (ABS), polystyrene (PS), polyvinyl chloride (PVC), PVC alloys, cyclic olefin copolymer (COC), poly(methyl methacrylate) (PMMA), polypropylene carbonate (PPC), polyether ether ketone (PEEK), polybutylene terephthalate (PBT), polyethylene terephthalate (PET), polyoxymethylene (POM), nylon, polyethylene (PE), polypropylene (PP), thermoplastic polyurethane (TPU), silicone, and combinations thereof.

In embodiments, the polymer is selected from the group consisting of polyethylenimine (PEI), acrylonitrile butadiene styrene (ABS), polyether ether ketone (PEEK), polyoxymethylene (POM), nylon, polypropylene (PP), thermoplastic polyurethane (TPU), silicone, and combinations thereof.

In embodiments, the polymer is selected from the group consisting of polyethylenimine (PEI), acrylonitrile butadiene styrene (ABS), polyether ether ketone (PEEK), polyoxymethylene (POM), nylon, polypropylene (PP), and combinations thereof.

In embodiments, the polymer is polyether ether ketone (PEEK).

In embodiments, the filler has a thermal conductivity of about 0.05 to about 0.20 W/mK.

In embodiments, the filler comprises glass microspheres, which may have a median particle size of about 15 to about 65 μm.

In embodiments, the filler has a density of less than about 0.65 g/cm³, such as from about 0.1 g/cm³ to about 0.5 g/cm³.

In embodiments, the polymeric composition has a thermal conductivity of less than about 0.4 W/mK, such as less than about 0.35 W/mK, less than about 0.30 W/mK, or less than about 0.25 W/mK.

In embodiments, the polymeric composition as a thermal conductivity of from about 0.10 W/mK to about 0.25 W/mK.

In embodiments, the polymeric composition comprises about 10 to about 90 wt. % polymer, such as from about 20 to about 80 wt. % polymer.

In embodiments, the polymeric composition comprises about 10 to about 90 wt. % filler, such as from about 20 to about 80 wt. % filler.

In embodiments, the aerosol provision device further comprises a heating element; and a receptacle configured to receive aerosol generating material, wherein the aerosol generating material is heatable by the heating element.

In embodiments, the heating element comprises an inductor coil configured to heat a susceptor, wherein, in use, the aerosol generating material is heatable by the susceptor.

In embodiments, the receptacle is at least partially covered by an insulating member of the one or more insulating members.

In embodiments, the inductor coil at least partially covers the insulating member such that the insulating member is positioned between the inductor coil and the receptacle.

In embodiments, the inductor coil is a substantially helical coil extending around the receptacle, and wherein the helical coil extends around the insulating member to at least partially cover the first insulating member.

In embodiments, the inductor coil is a substantially planar coil, and wherein the substantially planar coil at least partially covers the insulating member

In embodiments, the aerosol provision device further comprises an insulating member of the one or more insulating members within which the heating element is at least partially embedded.

In embodiments, the aerosol provision device further comprises an insulating member of the one or more insulating members at least partially covering the heating element such that the heating element is positioned between said insulating member and the receptacle.

In embodiments, the aerosol provision device further comprises a power source configured to supply electrical power to the heating element; and an insulating member of the one or more insulating members at least partially surrounding the power source.

In embodiments, the aerosol provision device further comprises one or more wireless charging components for recharging the power source; and an insulating member of the one or more insulating members at least partially surrounding the one or more wireless charging components.

In embodiments, the aerosol provision device further comprises the susceptor, optionally wherein the susceptor defines the receptacle.

In embodiments, the aerosol provision device further comprises an outer cover forming at least a portion of an outer surface of the aerosol provision device, wherein, in use, an outer surface of the outer cover is positioned away from an outer surface of the susceptor.

In embodiments, in use, a temperature of the outer surface remains below about 70° C., 60° C., 55° C. or about 48° C.

According to another aspect of the present disclosure, there is provided an aerosol provision system comprising: an aerosol provision device as described above; and an article comprising aerosol generating material. The article may be dimensioned to be at least partially received within the heating assembly.

The device may be a tobacco heating device, also known as a heat-not-burn device.

According to another aspect of the present disclosure, there is provided an outer cover for an aerosol provision device, wherein the outer cover comprises a polymeric composition as defined herein.

According to another aspect of the present disclosure, there is provided the use of a polymeric composition as an outer cover for an aerosol provision device, wherein the polymeric composition is as defined herein.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device.

FIG. 2 shows a front view of the aerosol provision device of FIG. 1 with an outer cover removed.

FIG. 3 shows a cross-sectional view of the aerosol provision device of FIG. 1.

FIG. 4 shows an exploded view of the aerosol provision device of FIG. 2.

FIG. 5A shows a cross-sectional view of a heating assembly within an aerosol provision device.

FIG. 5B shows a close-up view of a portion of the heating assembly of FIG. 5A.

FIG. 6 shows a cross-sectional view of an example of an aerosol provision device.

FIG. 7 is a close up cross-sectional view showing part of the aerosol provision device of FIG. 6.

FIG. 8A is an example of a cross-sectional view of a schematic representation of an aerosol provision system comprising an aerosol provision device and an aerosol generating article, the device comprising a plurality of substantially planar inductor coils and the article comprising a plurality of portions of aerosol generating material and corresponding susceptor portions; FIGS. 8B to 8D are a variety of views from different angles of the aerosol provision article of FIG. 8A.

FIGS. 9A and 9B show two different examples of a substantially planar inductor coil having a trapezoid shape.

FIG. 10A is a schematic representation of an aerosol provision system comprising an aerosol provision device and an aerosol generating article, the device comprising a single induction heating element and a movement mechanism, and the article comprising a plurality of portions of aerosol generating material; whereas FIGS. 10B and 10C are a couple of perspective views of parts of an aerosol provision system comprising an aerosol provision device and an aerosol generating article, wherein the aerosol provision device comprises a rotating device configured to rotate, about a rotation axis, the aerosol generating article relative to a heating element of the aerosol provision device.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. The article may also be referred to as a “consumable”.

A first aspect of the present disclosure defines an aerosol provision device comprising a polymeric composition which comprises (i) a polymer and (ii) a filler having a thermal conductivity of about 0.20 W/mK or less.

An aerosol provision device may comprise a receptacle configured to receive aerosol generating material, which is heatable by a susceptor. The receptacle may be, for example, defined by the susceptor such that the susceptor receives the aerosol generating material. For example, the susceptor may be substantially tubular (i.e. hollow) and can receive the aerosol generating material therein. In one example, the aerosol generating material is tubular or cylindrical in nature, and may be known as a “tobacco stick”, for example, the aerosol generating material may comprise plant-based material, such as tobacco, formed in a specific shape which is then coated, or wrapped in one or more other materials, such as paper or foil. Alternatively, the susceptor may not be a component of the device, but is attached to, or contained within the article introduced into the device.

The receptacle may define a heater chamber configured to receive aerosol generating material.

A susceptor can be heated by penetrating the susceptor with a varying magnetic field, produced by at least one inductor coil. The heated susceptor in turn heats the aerosol generating material located within the susceptor. The device therefore further comprises an inductor coil which at least partially covers the receptacle/susceptor. For example, the inductor coil may extend around the receptacle/susceptor.

In some embodiments, the receptacle/susceptor is surrounded by an insulating member which can be arranged coaxially with the receptacle/susceptor, for example. The insulating member may be positioned away from the outer surface of the receptacle/susceptor to provide an air gap. The coil may extend around the insulating member. In this case, the insulating member is located between the coil and the receptacle/susceptor. In certain arrangements the coil may be in contact with the insulating member. However, in other examples an air gap may be provided between the insulating member and the coil.

During use of the aerosol provision device the susceptor and the aerosol generating material are heated. However, other parts of the device may also be heated, for example by transfer of heat from the susceptor and/or the aerosol generating material. It is generally undesirable for parts of the device other than the susceptor and aerosol generating material to be heated. The device therefore comprises one or more insulating members. The insulating member(s) act to reduce the unwanted transfer of heat through the device. The insulating member(s) may insulate one or more components of the device (e.g. the battery and/or the outer cover) from the heated components (e.g. the susceptor and the aerosol generating material).

It has now been found that a polymeric composition which comprises (i) a polymer and (ii) a filler having a thermal conductivity of about 0.20 W/mK or less can provide good thermally insulating properties, and that such a composition is suitable for forming an insulating member in an aerosol provision device. Insulating members formed from the polymeric compositions described herein may be more effective at preventing or reducing the transfer of heat through the device than polymers which do not contain any filler, such as PEEK.

The insulating members described herein may be used in various locations in the device, including but not limited to:

at least partially covering the receptacle;
at least partially covering the inductor coil;
between the inductor coil and the receptacle;
at least partially containing the heating element (i.e, wherein the heating element is at least partially embedded in the insulating member);
at least partially covering the heating element, e.g. such that the heating element is positioned between the insulating member and the receptacle;
at least partially surrounding the power source; and
at least partially surrounding the one or more wireless charging components.

The polymeric composition generally comprises (i) a polymer and (ii) a filler having a thermal conductivity of about 0.20 W/mK or less.

In one aspect, the thermal conductivity of the filler is less than the thermal conductivity of the polymer.

The polymeric composition may comprise any amount of filler, such as from about 1 wt. % to about 99 wt. %, from about 10 wt. % to about 90 wt. %, from about 20 to about 80 wt. %, or from about 25 wt. % to about 75 wt. %.

The polymeric composition may comprise any amount of polymer, such as from about 1 wt. % to about 99 wt. %, from about 10 wt. % to about 90 wt. %, from about 20 to about 80 wt. %, or from about 25 wt. % to about 75 wt. %.

The weight ratio of polymer to filler may range from about 1:10 to about 10:1, such as from about 1:5 to about 5:1 or from about 1:2 to about 2:1.

In one aspect, the polymeric composition may include one or more additional fillers, such as colorants. If present, any additional fillers constitute about 10 wt. % or less, such as about 5 wt. % or less or about 1 wt. % or less of the polymeric composition.

In one aspect, the polymeric composition consists essentially of polymer, the filler described herein, and optionally one or more additional fillers. In one aspect, the one or more insulating member consists essentially of polymer, the filler described herein, and optionally one or more additional fillers.

In one aspect, the polymeric composition consists of polymer, the filler described herein, and optionally one or more additional fillers. In one aspect, the one or more insulating member consists of polymer, the filler described herein, and optionally one or more additional fillers.

The polymer may be any polymer suitable for use in an aerosol generating device, such as an elastomer or a thermoplastic polymer. The thermoplastic polymer may be amorphous or semi-crystalline.

In one aspect, the polymer is selected from the group consisting of polycarbonate (PC), polyethylenimine (PEI), acrylonitrile butadiene styrene (ABS), polystyrene (PS), polyvinyl chloride (PVC), PVC alloys, cyclic olefin copolymer (COC), poly(methyl methacrylate) (PMMA), polypropylene carbonate (PPC), polyether ether ketone (PEEK), polybutylene terephthalate (PBT), polyethylene terephthalate (PET), polyoxymethylene (POM), nylon, polyethylene (PE), polypropylene (PP), thermoplastic polyurethane (TPU), silicone, and combinations thereof.

The polyethylene may be ultra-high-molecular-weight polyethylene (UHMWPE), high-density polyethylene (HDPE), or low-density polyethylene (LDPE).

In one aspect, the polymer is selected from the group consisting of polyethylenimine (PEI), acrylonitrile butadiene styrene (ABS), polyether ether ketone (PEEK), polyoxymethylene (POM), nylon, polypropylene (PP), thermoplastic polyurethane (TPU), silicone, and combinations thereof.

In one aspect, the polymer is selected from the group consisting of polyethylenimine (PEI), acrylonitrile butadiene styrene (ABS), polyether ether ketone (PEEK), polyoxymethylene (POM), nylon, polypropylene (PP), and combinations thereof.

In one aspect, the polymer is polyether ether ketone (PEEK). PEEK has good insulating properties and is well suited for use in an aerosol provision device. PEEK has a thermal conductivity of about 0.32 W/mK.

In one aspect, the polymer has a thermal conductivity of greater than about 0.20 W/mK, such as from about 0.25 W/mK to about 0.45 W/mK or from about 0.30 W/mK to about 0.40 W/mK.

The filler has a thermal conductivity of about 0.20 W/mK or less. In one aspect, the filler has a thermal conductivity of from about 0.05 to about 0.20 W/mK.

In one aspect, the filler comprises glass microspheres, which may have a median particle size of about 15 to about 65 μm. In some embodiments, the glass microspheres may be hollow glass microspheres.

In one aspect, the filler has a density of less than about 0.65 g/cm³, such as from about 0.1 g/cm³ to about 0.5 g/cm³.

Suitable fillers for use in the present invention are commercially available (for example from 3M™ and Trelleborg Applied Technologies). Suitable commercially available fillers having the required thermal conductivity include Glass Bubbles iM16K and iM30K from 3M™ and SI-100 from Trelleborg. However, other suitable fillers are available, and the skilled person could select suitable fillers having the required thermal conductivity without difficulty.

In one aspect, the polymeric composition has a thermal conductivity of less than about 0.4 W/mK, such as less than about 0.35 W/mK, less than about 0.30 W/mK, or less than about 0.25 W/mK.

In one aspect, the polymeric composition as a thermal conductivity of from about 0.10 W/mK to about 0.25 W/mK.

The insulating member may have a thickness of from about 0.25 mm to about 1 mm. For example, the insulating member may have a thickness of from about 0.25 mm to about 0.75 mm, such as from about 0.4 mm to about 0.6 mm, e.g. about 0.5 mm. It has been found that these thicknesses represent a good balance between reducing heating of the insulating member and coil (by making the insulating member thinner to increase the air gap size), and increasing the robustness of the insulating member (by making it thicker).

As discussed above, the insulating member may be located between the coil and the receptacle/susceptor.

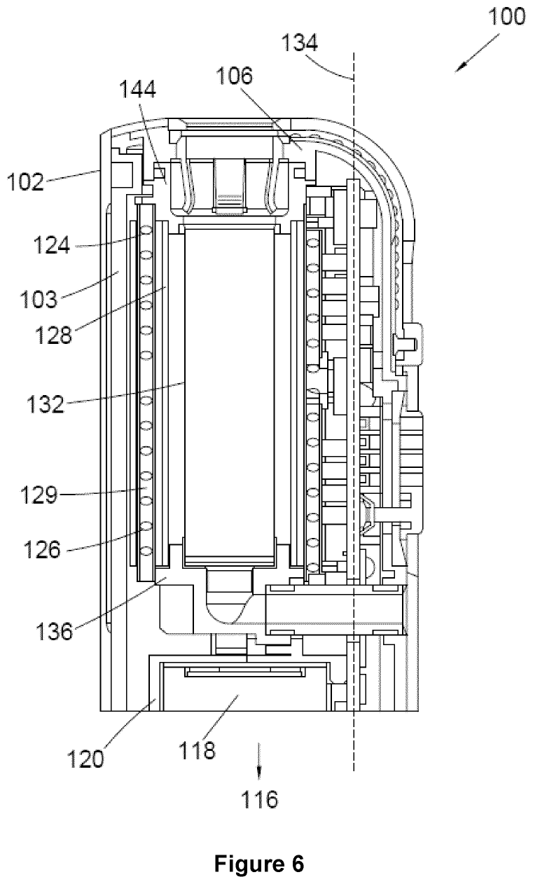

In some embodiments, the aerosol provision device comprises a heating element and a receptacle configured to receive aerosol generating material, wherein the aerosol generating material is heatable by the heating element. The receptacle may be at least partially covered by an insulating member of the one or more insulating members, as will be described below in relation to FIGS. 6-10.

The inductor coil may extend around the susceptor/receptacle in a helical fashion. The susceptor may define a longitudinal axis, such that the insulating member extends around the longitudinal axis in an azimuthal direction, therefore forming a full or partial tube-like structure.

The aerosol provision device may comprise two or more inductor coils. For example, a first inductor coil may extend around a first portion the receptacle/susceptor, and a second inductor coil may extend around a second portion of the receptacle/susceptor. The first and second inductor coils may be arranged adjacent to each other in a direction along the longitudinal axis of the receptacle/susceptor. In such a device, an insulating member may be in contact with, and extend at least partially around, the first and second inductor coils.

In some examples the aerosol provision device comprises the susceptor, and the susceptor defines the receptacle.

In some examples, the device comprises two or more inductor coils arranged along the length of the susceptor and between each adjacent inductor coil the device comprises a radially extending wall, such as a washer.

In some examples, the radially extending wall can extend at least partially around the susceptor to separate each inductor coil. It has been found that such radially extending walls act to decouple the induction coils meaning each coil acts independently, i.e. there are no or lower induced effects in a neighbouring non-operated coil. The magnetic flux from each inductor coil can therefore be more localized. In some examples, the walls can help channel/focus energy into the article at location of the wall, which can mean that the total number of coils can be reduced. The radially extending walls can act as a collar around the susceptor. The radially extending wall may be coaxial with the susceptor. Radially extending may mean that the wall extends in a direction parallel to a radius of the tubular susceptor.

In some examples, the wall is attached to (i.e. in contact with) the susceptor. For example, it may extend from the susceptor to the inductor coils. In other examples, the wall is not attached to the susceptor. For example, it may extend from the outer surface of the insulating member. In one example, the walls and susceptor are made from the same material. In a particular example, the walls comprise ferrite.

Accordingly, in one example, there is provided an aerosol provision device, comprising a susceptor, a first inductor coil extending around a first region of the susceptor and a second inductor coil extending around a second region of the susceptor, wherein the device further comprises a radially extending electromagnetic shield member arranged between the first inductor coil and the second inductor coil.

The one or more insulating members may create a thermal barrier between the hot susceptor and the outer casing/housing of the device. In examples, an outer cover of the device is maintained below about 75° C., such as below about 70° C., 60° C., 55° C. or 48° C. In other examples, the outer cover of the device is maintained below 45° C. or below 43° C. during use. In some examples, the outer cover of the device is maintained below 43° C. for at least 3 or 4 back-to-back heating sessions. A session includes heating the article for a period of between about 3 minutes to about 4 minutes until the aerosol generating material is spent. The use of an insulating member around the inductor coils may reduce the surface temperature of the outer cover by up to 3° C. Additional, or alternative insulation features, such as the use of an air gap between the susceptor and insulating member can also maintain the temperature of the outer cover below about 48° C.

Accordingly, in another aspect, an aerosol provision device comprises an inductor coil and a susceptor configured to heat aerosol generating material, wherein the inductor coil is arranged to heat the susceptor. The device comprises an outer cover forming at least a portion of an outer surface of the aerosol provision device, wherein an outer surface of the outer cover is positioned away from an outer surface of the susceptor. In use, a temperature of the outer surface remains below about 75° C., such as below about 70° C., 60° C., 55° C. or about 48° C.

Accordingly, the device remains below about 75° C., such as below about 70° C., 60° C., 55° C. or about 48° C. for at least one heating session. In some examples, in use, the temperature of the outer surface remains below about 43° C.

In one aspect, in use, the temperature of the outer surface remains below about 43° C. for a period of at least three heating sessions, wherein a heating session lasts for at least 180 seconds. Accordingly, in use, the temperature of the outer surface remains below about 43° C. for a period of at least 540 seconds. A heating session means that the susceptor is being continuously heated during this time. In some examples, the average temperature of the susceptor during a heating session is between about 240° C. and about 300° C. Preferably the heating sessions are performed back-to-back (i.e. begin within less than about 30 seconds, or less than about 20 seconds, or less than about 10 seconds of each other).

In another aspect, in use, the temperature of the outer surface remains below about 43° C. for a period of at least four heating sessions.

In some examples, a heating session lasts for at least 210 seconds.

The device may further comprise an electromagnetic shield member in contact with, and extending at least partially around, the coil.

As discussed above, the device may comprise an insulating member at least partially covering or extending around the susceptor. The insulating member can help maintain the temperature of the outer surface below about 48° C. In some examples, the insulating member is positioned away from the susceptor to provide an air gap around the susceptor. The air gap provides an additional thermal barrier.

However, as will be appreciated, providing an insulating member with the thermal insulating properties as described herein may negate the need to provide an air gap to provide an additional thermal barrier, such that the device 100 may be advantageously smaller as a result.

In one embodiment, each of the one or more insulating members may have a melting point/temperature greater than about 250° C. By having the melting point above 250° C., the structural integrity of the insulating member is retained when the susceptor is heated. In one embodiment, the insulating member has a melting point/temperature above 300° C.

In another aspect, the insulating member may have a melting point of greater than about 320° C., such as greater than about 300° C., or greater than about 340° C. PEEK has a melting point of 343° C. Insulating members with such melting points ensure that the insulating member remains rigid/solid when the susceptor is heated.

The inner surface of the outer cover may be positioned away from the outer surface of the insulating member by a distance of greater than 0 mm and less than about 3 mm. A separation distance of this size may provide enough insulation to ensure that the outer cover does not get too hot. Air may be located between the outer surface of the insulating member and the outer cover. In one aspect, the inner surface of the outer cover is not in direct contact with the insulating member. This can avoid a thermally conductive path between the inner surface of the outer cover and the insulating member.

In use, the inductor coil may be configured to heat the susceptor to a temperature of between about 200 and about 300° C. In use, the inductor coil may be configured to heat the susceptor to a temperature of about 350° C.

The inductor coil may be substantially helical. The inductor coil may be a spiral coil. For example, the inductor coil may be formed from wire, such as Litz wire, which is wound helically around the coil support.

The inductor coil, the susceptor and the insulating member may be coaxial.

In some examples, in use, the inductor coil is configured to heat the susceptor to a temperature of between about 200° C. and about 350° C., such as between about 240° C. and about 300° C., or between about 250° C. and about 280° C.

An inner surface of the outer cover may be positioned away from an outer surface of the susceptor by a distance of between about 4 mm and about 6 mm. This distance is the distance between the outer surface of the susceptor and the inner surface of the outer cover at its closest point. The distance may therefore be the minimum distance between the outer surface of the susceptor and the inner surface of the outer cover. In one example, the distance may be measured between the susceptor and a side surface of the device.

In some examples, in use, the coil is configured to heat the susceptor to a temperature of between about 240° C. and about 300° C., such as between about 250° C. and about 280° C. When the outer cover is spaced apart from the susceptor by at least this distance, the temperature of the outer cover remains at a safe level, such as less than about 48° C., or less than about 43° C.

In one example, the inner surface of the outer cover is positioned away from the outer surface of the susceptor by a distance of between about 5 mm and about 6 mm. Preferably, the inner surface of the outer cover is positioned away from the outer surface of the susceptor by a distance of between about 5 mm and about 5.5 mm, such as between about 5.3 mm and about 5.4 mm. A spacing within this range of distances provides better insulation while also ensuring that the device remains small and lightweight. In a particular example, the spacing is 5.3 mm.

However, by including one or more of the insulating members described herein, the distance between the outer surface of the susceptor and the inner surface of the outer cover at its closest point could be reduced, whilst still remaining insulated enough from the heated susceptor to keep the surface temperature of the outer cover at a safe level, such as less than about 48° C., or less than about 43° C. Thus, in one aspect the inner surface of the outer cover may be positioned away from an outer surface of the susceptor by a distance of from about 3 mm to about 5 mm, such as from about 4 mm to about 5 mm.

The outer cover may also be known as an outer casing. The outer casing may fully surround the device, or may extend partially around the device.

In some examples, the outer surface of the outer cover comprises a coating. The coating and/or outer cover may have a high thermal conductivity. For example, the conductivity may be greater than about 200 W/mK. A relatively high thermal conductivity ensures that heat disperses throughout the outer cover, which in turn is lost to the atmosphere, thereby cooling the device. In a particular example, the coating is soft touch paint.

The device may further comprise at least one insulation layer, wherein the at least one insulation layer may be an insulating member of the one or more insulating members comprising at least any or all of the features described in relation to the above aspects. The at least one insulation layer is positioned between the outer cover and the susceptor. The insulation layer insulates the outer cover from the susceptor.

An insulation layer may be located in any or all of the following locations: (i) between the susceptor and an insulating member, (ii) between the insulating member and the coil, (iii) between the coil and outer cover. In (ii), the insulating member may have a smaller outer diameter to accommodate the insulation layer. Additionally, or alternatively, the coil may have a larger inner diameter to accommodate the insulation layer. The insulation layer may comprise multiple layers of materials.

Accordingly, the insulation layer may be provided by the polymeric composition comprising at least any or all of the features described in relation to the above aspects. However, the insulation layer may additionally or alternatively be provided by any of the following materials (i) air (which has a thermal conductivity of about 0.02 W/mK), (ii) a polyimide aerogel such as AeroZero® (which has a thermal conductivity of between about 0.03 W/mK and about 0.04 W/mK), (iii) polyether ether ketone (PEEK), (iv) ceramic cloth (which has a specific heat of about 1.13 KJ/kgK), (v) thermal putty.

In some examples, an air gap is formed between the coil and the outer cover. The air gap provides insulation.

In some examples, the device comprises a temperature sensor arranged to measure a temperature of the battery. The device may comprise a controller that is configured to cause the device to stop heating when the temperature of the battery is equal to or greater than a threshold temperature. The threshold temperature may be about 45° C. or 50° C., for example.

The inner surface of the outer cover may be positioned away from an outer surface of the coil by a distance of between about 0.2 mm and about 1 mm. In some examples the coil itself may heat up as it is used to induce a magnetic field, for example from resistive heating due to the current passing through it to induce the magnetic field. Providing a spacing between the coil and outer cover ensures that the heated coil is insulated from the outer cover. In some examples, an insulating member is located between the inner surface of the outer cover and the coil. This additionally helps insulate the inner surface of the outer cover.

In one example, the coil comprises litz wire, and the litz wire has a circular shaped cross section. In such an example, the inner surface of the outer cover is positioned away from the outer surface of the coil by a distance of between about 0.2 mm and about 0.5 mm, or between about 0.2 mm and about 0.3 mm such as about 0.25 mm.

In one example, the coil comprises litz wire, and the litz wire has a rectangular shaped cross section. In such an example, the inner surface of the outer cover is positioned away from an outer surface of the coil by a distance of between about 0.5 mm and about 1 mm, or between about 0.8 mm and about 1 mm, such as about 0.9 mm. A litz wire with a circular cross section can be arranged closer to the outer cover than a litz wire with a rectangular cross section because the circular cross section wire has a smaller surface area exposed towards the outer cover.

The inner surface of the coil may be positioned away from the outer surface of the susceptor by a distance of between about 3 mm and about 4 mm.

The outer cover may comprise aluminum. Aluminum has good heat dissipation properties. The outer cover may have a thermal conductivity of between about 200 W/mK and about 220 W/mK. For example, aluminum has a thermal conductivity of around 209 W/mK. Thus, the outer cover may have a relatively high thermal conductivity to ensure that it heat disperses throughout the outer cover, which in turn is lost to the atmosphere, thereby cooling the device.

The outer cover may have a thickness of between about 0.75 mm and about 2 mm. The outer cover can therefore also act as an insulating barrier. These thicknesses provide a good balance between providing good insulation and reducing the size and weight of the device. Preferably the outer cover has a thickness of between about 0.75 mm and about 1.25 mm, such as about 1 mm.

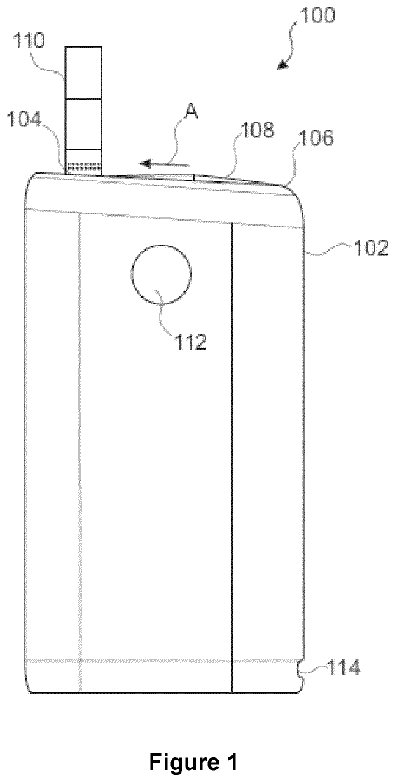

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100. The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heating assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port. The device 100 may additionally or alternatively comprise one or more electrical components forming a wireless charging assembly for charging the battery of the device 100. The one or more electrical components forming the wireless charging assembly may be surrounded by one or more insulating members so as to be thermally isolated from other components of the device 100.

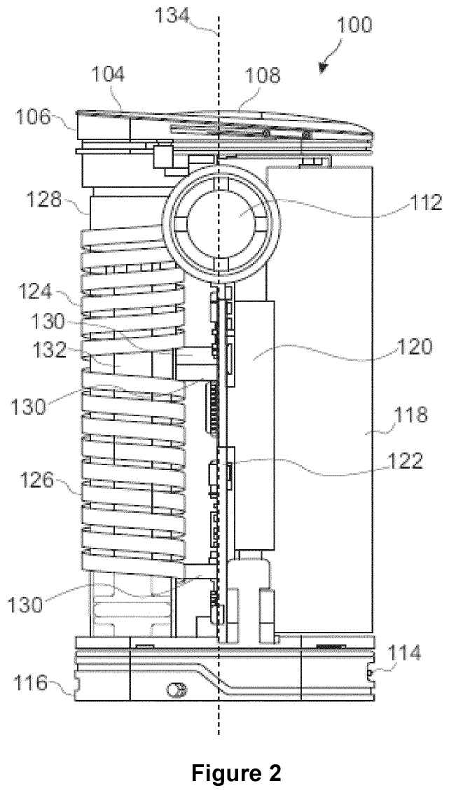

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100. The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery, (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks. In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

Although the heating assembly of example device 100 is shown and described herein as an induction heating assembly, it is to be understood that the heating assembly could be something other than an induction heating assembly, for example a resistive heating assembly. For instance, the coils 124, 126, 224a, 1000, 90, 324 shown in the Figures and described below may instead be resistive heating elements of a resistive heating assembly, which may provide heat via Joule heating from a running an electric current through said resistive heating elements, such that at least a portion of a corresponding article may be heated.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular. The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This is can be useful when the inductor coils are active at different times. For example, initially, the first inductor coil 124 may be operating to heat a first section of the article 110, and at a later time, the second inductor coil 126 may be operating to heat a second section of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The device 100 of FIG. 2 further comprises an insulating member 128 which may be generally tubular and at least partially surround the susceptor 132. The insulating member 128 is constructed from the polymeric composition described herein. The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

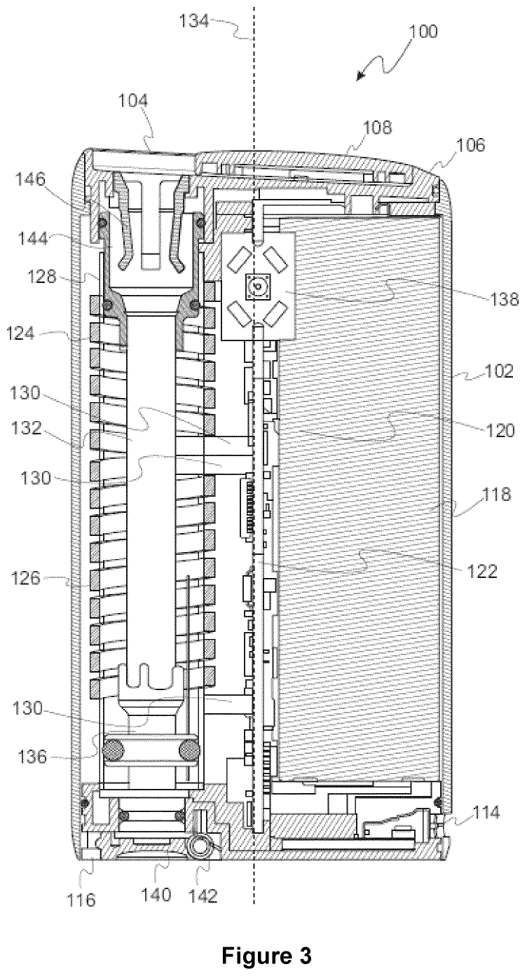

FIG. 3 shows a side view of device 100 in partial cross-section. The outer cover 102 is present in this example. The rectangular cross-sectional shape of the first and second inductor coils 124, 126 is more clearly visible. The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

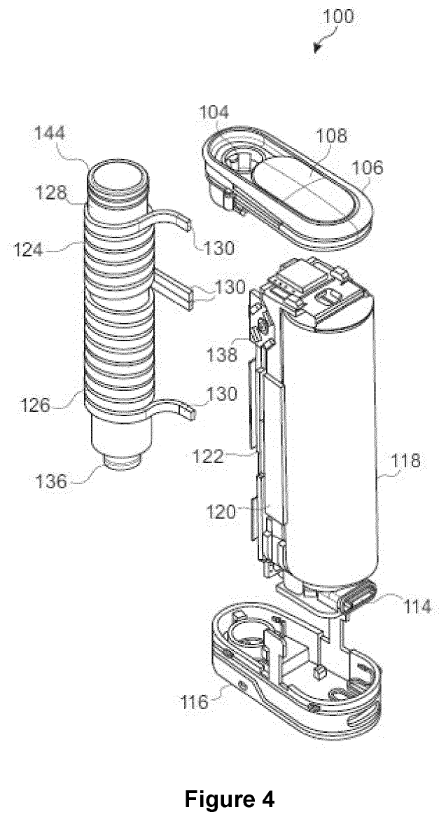

FIG. 4 is an exploded view of the device 100 of FIG. 1, with the outer cover 102 omitted.

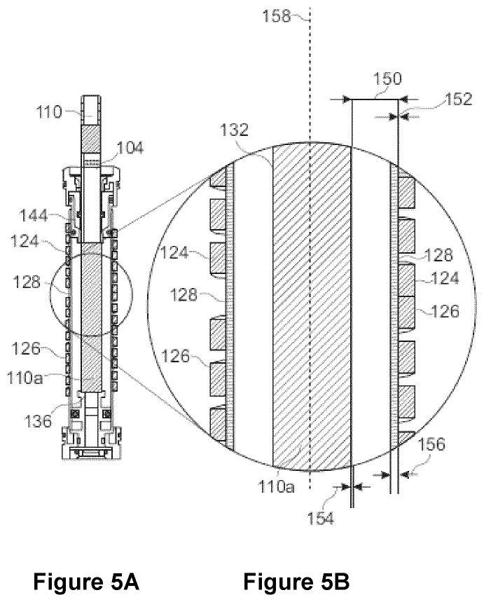

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

The susceptor 132 receives an article 110 and therefore defines a receptacle configured to receive aerosol generating material. In other examples (not shown) the susceptor 132 is part of the article 110, rather than the device 100, and so other components may define the receptacle. The receptacle/susceptor 132 may define an axis 134, such as a longitudinal axis 134, around which the one or more insulating members may be wrapped. In embodiments where the susceptor is part of the article, one or more insulating members may define the receptacle.

Referring now to FIG. 6, there is shown a device 100 which is substantially similar to the device 100 shown in FIGS. 1-5, although the battery 118 is shown longitudinally below the susceptor 132. As can be seen in FIG. 6, the device 100 may comprise one or more insulating members shown by the shaded regions.

For instance, as shown, insulating member 128 extends between the expansion chamber 144 and the support 136.

The expansion chamber 144, which engages the proximal end of the susceptor 132 to hold the susceptor 132 in place, may also be an insulating member according to embodiments described herein. That is, the expansion chamber 144 may comprise the polymeric composition described herein.

The end member 106, to which the expansion chamber 144 is connected to, may also be an insulating member according to embodiments described herein. That is, the end member 106 may comprise the polymeric composition described herein.

The support 136, which engages one end of the susceptor 132, may also be an insulating member according to embodiments described herein. That is, the support 136 may comprise the polymeric composition described herein.

Although not shown in FIG. 6, the first end member 116, arranged at the opposite end of the device 100 to the first end member 106, may also be an insulating member according to embodiments described herein. That is, the first end member 116 may comprise the polymeric composition described herein.

The central support 120, which holds the battery 118, may also be an insulating member according to embodiments described herein. That is, the central support 120 may comprise the polymeric composition described herein.

The device 100 may further comprise a coil support 129 acting as a support member. The support member may be generally tubular and at least partially surround the susceptor 132. However, in embodiments wherein the inductor coil may be other than helical (as described below), the coil support 129 may take a shape substantially corresponding to the inductor coil so as to support the inductor coil. The support member 129 supports the first and second inductor coils 124, 126. The coil support 129 may also extend between the support 136 and the expansion chamber 144. The coil support 129 together with the support 136 and the expansion chamber 144 therefore enclose the heating assembly. That is, the coil support 129 together with the support 136 and the expansion chamber 144 enclose the inductor coils 124, 126 and the susceptor 132 as shown.

As will be understood, in embodiments wherein the device comprises a resistive heating assembly, the coil support 129 may instead be a resistive heating element support 129, and said resistive heating element support 129 together with the support 136 and the expansion chamber 144 enclose the receptacle for receiving the article in use.

The coil support 129 or resistive heating element support 129 therefore assists with thermally isolating the heating assembly from other components of the device 100.

Returning to FIG. 6, the coil support 129 may be a hollow, tubular member.

In embodiments, the coil support 129 may also be an insulating member according to embodiments described herein. Coil supports formed from such materials ensure that the assembly remains rigid/solid when the susceptor is heated, whilst also limiting the transfer of heat to other parts of the device (e.g. the outer surface). In embodiments, the coil support 129 may be an assembly of two or more parts. The coil support 129 may further act as a chassis to aid assembly of the device 100.

As shown in FIG. 6, the coil support 129 substantially surrounds the inductor coils 124, 126 such that they are at least partially embedded within coil support 129. For instance, the inductor coils 124, 126 may be fully embedded within coil support 129 as shown in FIG. 6.

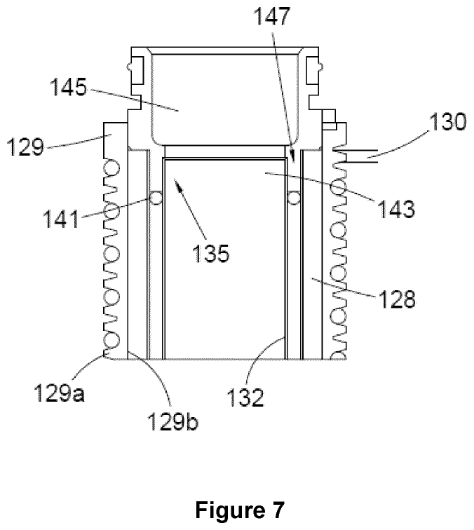

However, in other embodiments, the first and second inductor coils 124, 126 are positioned around the coil support 129 and abut the coil support 129 on a radially outward side 129a of the coil support 129 (as shown in FIG. 7). FIG. 7 is a close up cross sectional view showing part of the aerosol provision device of FIG. 6. The expansion chamber 144 comprises an insertion chamber 145. The insertion chamber 145 is configured to receive the article 110 therethrough. The insertion chamber 145 has an inner diameter greater than the diameter of the article 110. The expansion chamber 144 forms a first, proximal, collar for the heater assembly 105. A bore 143 extends therethrough. As shown in FIG. 7, a distally facing shoulder 147 is defined on the inner surface of the bore 143. The distally facing shoulder 147 locates with the lip 135 of the susceptor 132 when the susceptor is received by the expansion chamber 144. A first sealing member 141 forms a fluid seal between the heating assembly and the expansion chamber 144. The first sealing member 141 is a circumferentially extending member. The first sealing member 141 comprises a silicon rubber seal. Other suitable materials may be used.

In other embodiments, the first and second inductor coils are on a radially inward side 129b of the coil support 129.

The susceptor 132, the coil support 129, and the first and second inductor coils 124, 126 may be coaxial around the central longitudinal axis 134 of the susceptor 132. The coil support 129 may further help insulate the various components of the device 100 from the heat generated in the susceptor 132.

As will be understood, the outer cover 102, as shown in FIG. 6, provides protection to the internal components of the device, and is generally in contact with a user's hand when the device is in use. The outer cover 102 comprises an inner surface and an outer surface.

In some examples the inductor coil itself may heat up as it is used to induce a magnetic field, for example from resistive heating due to the current passing through it to induce the magnetic field. In embodiments comprising resistive heating elements, it is even more crucial to insulate said resistive heating element from the outer cover 102.

Accordingly, providing an insulating cover layer 103 between the inductor coil (or resistive heating elements) and outer cover 102 helps ensure that the heated inductor coil (or any other heat-generating components of the device or system) is insulated from the outer cover 102. As will be understood, the insulating cover layer 103 may also be an insulating member according to embodiments described herein. That is, the insulating cover layer 103 may comprise the polymeric composition described herein. The insulating cover layer 103 may line or cover at least a portion of the inner surface of the outer cover 102, or may line substantially all of the inner surface of the outer cover 102.

The inner surface of the outer cover 102 may be positioned away from the outer surface of the insulating cover member 103 by a distance such that an air gap therebetween provides enough insulation to ensure that the outer cover does not get too hot.

The inner surface of the outer cover 102 may be positioned away from an outer surface of the next radially inner component (such as coil support 129 and inductor coil) by a such that an air gap therebetween provides further insulation.

Furthermore, the inner surface of the inductor coil and/or coil support 129 may be positioned away from the outer surface of the susceptor 132 by a distance such that an air gap therebetween provides further insulation.

However, as will be appreciated, providing an insulating member with the thermal insulating properties as described herein may negate the need to provide such air gaps to provide additional thermal barriers (or allow the air gaps to be smaller), such that the device 100 may be advantageously smaller as a result.

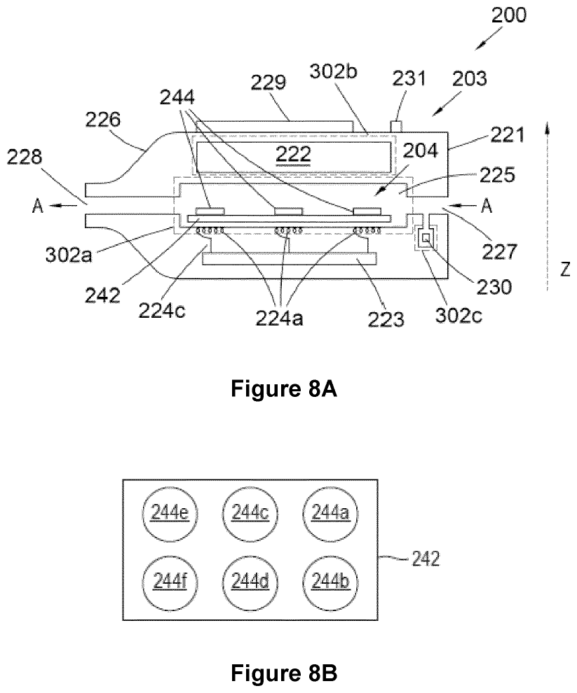

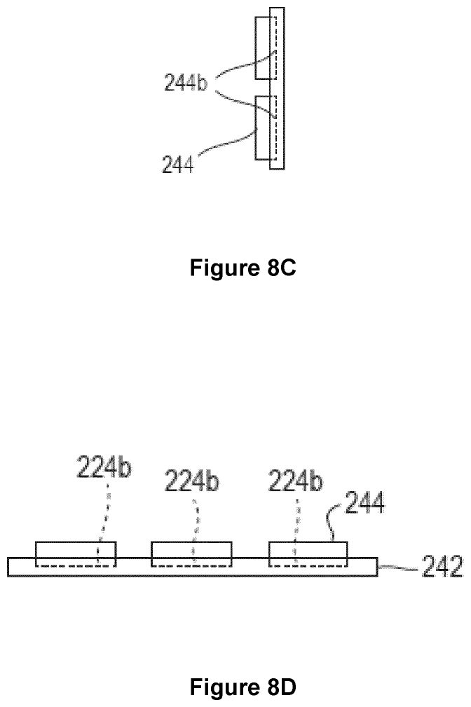

FIG. 8A is a cross-sectional view through a schematic representation of an aerosol provision system 200 in accordance with another embodiment of the disclosure. The aerosol provision system 200 comprises two main components, namely an aerosol provision device 203 and an aerosol generating article 204.

The aerosol provision device 203 comprises an outer housing 221, a power source 222, control circuitry 223, a plurality of aerosol generating components 224, a receptacle or aerosol forming chamber 225, a mouthpiece end 226, an air inlet 227, an air outlet 228, a touch-sensitive panel 229, an inhalation sensor 230, and an end of use indicator 231.

The outer housing 221 may be formed from any suitable material, for example a plastics material. In one aspect, the outer housing may be formed from the same polymeric composition disclosed herein. That is, the outer house may be an insulating member as described herein. In embodiments, an insulating member may be positioned immediately inside of the inner surface of the outer housing 221, with or without an air gap provided therebetween.

The outer housing 221 is arranged such that the power source 222, control circuitry 223, aerosol generating components 224, receptacle 225 and inhalation sensor 230 are located within the outer housing 221. The outer housing 221 also defines the air inlet 227 and air outlet 228. The touch sensitive panel 229 and end of use indicator are located on the exterior of the outer housing 221.

In the described implementation, the aerosol provision device 203 further comprises a receptacle 225 which is arranged to receive an aerosol generating article 204. In embodiments, the receptacle 225 may be formed from the same polymeric composition disclosed herein. That is, the receptacle 225 may be defined by an insulating member.

The aerosol generating article 204 comprises a carrier component, aerosol generating material 244, and susceptor elements 244b, as shown in more detail in FIGS. 8B to 8D. FIG. 8B is a top-down view of the article 204, FIG. 8C is an end-on view along the longitudinal (length) axis of the article 204, and FIG. 8D is a side-on view along the width axis of the article 204.

FIGS. 8A to 8D represent an aerosol provision system 200 which uses induction to heat the aerosol generating material 244 to generate an aerosol for inhalation. However, as discussed above, aerosol provision system 200 may instead or additionally use resistive heating to heat the aerosol generating material 244. In such embodiments, the components labelled 224a in FIG. 8A could be resistive heating elements.

In the described implementation, the aerosol generating component 224 is formed of two parts; namely, induction heating elements such as inductor coils 224a which are located in the aerosol provision device 203 and susceptors 224b which are located in the aerosol generating article 204. In embodiments, the induction heating elements may comprise one or more of: (i) a flat spiral coil, wherein the spiral coil comprises a circular or ovular spiral, a square or rectangular spiral, a trapezoidal spiral, or a triangular spiral; (ii) a multi-layered induction arrangement wherein subsequent full or partial turns of the coil are provided on adjacent layers, optionally wherein a first layer is spaced from a second layer in a first direction and a third layer is spaced from the second layer in the opposite direction to reside in or close to the first layer such that the multi-layered induction arrangement forms a staggered structure; or (iii) a three-dimensional inductor coil, such as a regular helix or a conically shaped inductor coil, optionally with a varying helical pitch.

Accordingly, in this described implementation, each aerosol generating component 224 comprises elements that are distributed between the aerosol generating article 204 and the aerosol provision device 203.

As seen in FIGS. 8C and 8D, the carrier component 242 comprises a number of susceptors 224b which correspond in size and location to the discrete portions of aerosol generating material 244 disposed on the surface of the carrier component 242. That is, the susceptors 224b have a similar width and length to the discrete portions of aerosol generating material 244.

The susceptors are shown embedded in the carrier component 242. However, in other implementations, the susceptors 224b may be placed on the surface of the carrier component 242. In another implementation (not shown), the susceptor may be provided as a layer substantially covering the carrier component.

The aerosol provision device 203 comprises a plurality of inductor coils 224a shown schematically in FIG. 8A. The inductor coils 224a are shown adjacent the receptacle 225, and are generally flat coils arranged such that the rotational axis about which a given coil is wound extends into the receptacle 225 (e.g., parallel with the z-axis as indicated in FIG. 8A) and is broadly perpendicular to the plane of the carrier component 242 of the article 204. The exact windings are not shown in FIG. 8A and it should be appreciated that any suitable induction coil may be used.

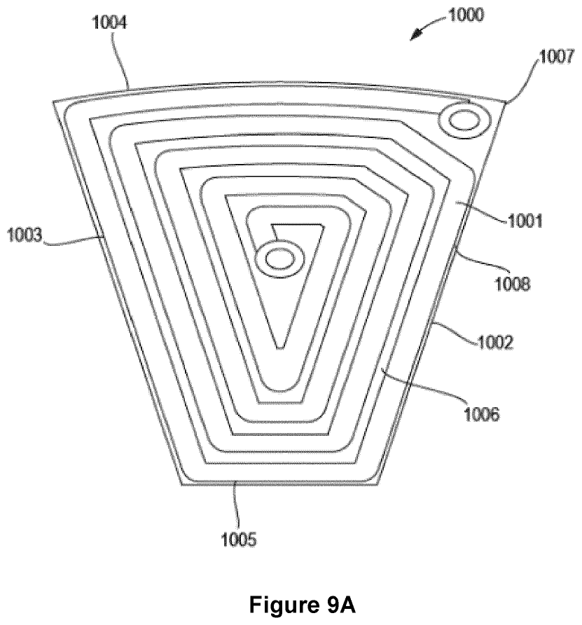

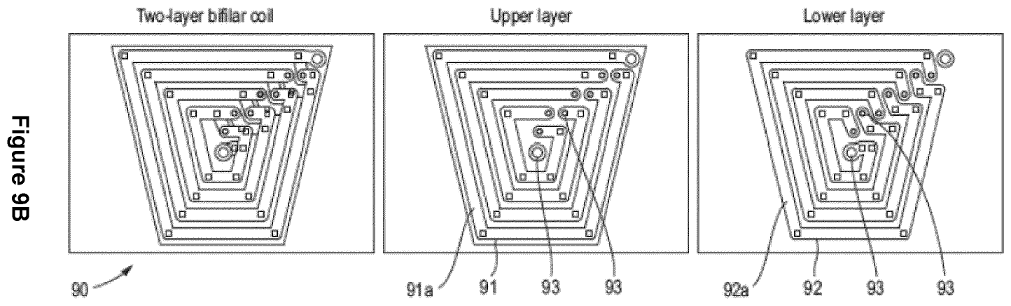

FIGS. 9A and 9B two different examples of a substantially planar or flat inductor coil.

FIG. 9A shows a trapezoid shaped inductor arrangement 1000. The trapezoid shaped inductor arrangement may comprise an electrically-conducting track 1001, for example a copper track. As show, the electrically-conducting track 1001 may form an inductor coil in a substantially trapezoidal shape, wherein the substantially trapezoidal shape comprises: a first angled side 1002; a second angled side 1003; a long side 1004; and a short side 1005 shorter in length than the long side 1004.

Referring to FIG. 9B, there is shown an embodiment of a substantially planar inductor coil comprising a layered inductor arrangement 90, wherein the layered inductor arrangement 90 is a two-layer bifilar coil inductor arrangement 90 comprising a first layer 91 and a second layer 92. The layered inductor arrangement 90 of FIG. 9B is shown as a trapezoid shaped inductor arrangement, however it will be understood that the layered inductor arrangement could have any number of shapes such as circular, square, rectangular, etc, or be irregularly shaped. The first layer 91 comprises one or more first electrically-conductive wires or tracks 91a, and the second layer 92 comprises one or more second electrically-conductive wires or tracks 92a. The first 91a and second 92a electrically-conductive wires or tracks may be concentric and substantially over-lapping when viewed from a perspective face-on to the layers, as shown in FIG. 9. One or more electrically-conductive linking portions 93 connect one or more of the first electrically-conductive wires or tracks 91a to the second electrically-conductive wires or tracks 92a. In embodiments, the layered inductor arrangement 90 may be formed in a PCB format, wherein the vertical plane can be used and adding to the already low aspect ratio (height of copper track to width) enhances further the effect. It has been found that coupling the wires or tracks vertically instead of horizontally further enhances the mutual coupling or capacitive linking of the wires, while minimising the phase shift between them.

Accordingly, in embodiments, the inductor coil is a substantially planar coil defining a first substantially planar surface on a first side of the inductor coil (e.g., with the normal to the first surface directed along the z-axis so as to face towards the receptacle 225), a second substantially planar surface on a second side of the inductor coil opposite the first side (e.g., with the normal to the second surface directed along the z-axis in the opposite direction to the normal of the first surface so as to face away from the receptacle 225), and a perimeter surface connecting the first and second substantially planar surfaces (e.g., the surface defining the sides 1002-1005 in FIG. 9A).

Referring back to FIGS. 8A-8D, covering the inductor coils 224a is an insulating member 302a (indicated by the dashed lines). This insulating member 302a may be in contact with, and substantially cover, the inductor coils 224a to thermally isolate other components of the device 203 and/or other objects from heat generated within the susceptor and/or inductor coils 224a. For instance, the insulating member 302a may substantially extend around the receptacle 225 so as to surround both the inductor coils 224a and the receptacle 225 with the susceptors 224b arranged therein. Similar to the embodiments described in relation to FIGS. 6 and 7, the inductor coils 224a may be partially or substantially entirely embedded within the insulating member 302a.

However, it will be understood that other designs of the insulating member are possible, for example being in the form of a cap (not shown) corresponding to one or more of the inductor coils 224a so as to cover at least the second surface of the one or more inductor coils 224a facing away from the receptacle 225 and the perimeter surface of the one or more inductor coils 224a.

The one or more ends 224c of each inductor coil 224a may pass through notches/openings/apertures formed in the insulating member 302a. However, the one or more ends 224c of each inductor coil 224a may themselves be encapsulated or within an insulating member. Moreover, the insulating member 302a may comprise further notches/openings/apertures such that the air flow path between air inlet 227 and air outlet 228 is unimpeded by the insulating member 302.

As will be appreciated, one or more insulating members may be provided around any component within device 203 where it is desired to have thermal insulation. For example, further insulating members may include, but not limited to, an insulating member 302b at least partially surround battery 22; and/or an insulating member 302c at least partially surrounding inhalation sensor 302c. Although the above has described an induction heating aerosol provision system where the inductor coils 224a and susceptors 224b are distributed between the article 204 and device 203, an induction heating aerosol provision system may be provided where the inductor coils 224a and susceptors 224b are located solely within the device 203. For example, with reference to FIGS. 8B-8C, the susceptors 224b may be provided above the inductor coils 224a and arranged such that the susceptors 224b contact the lower surface of the carrier component 242.

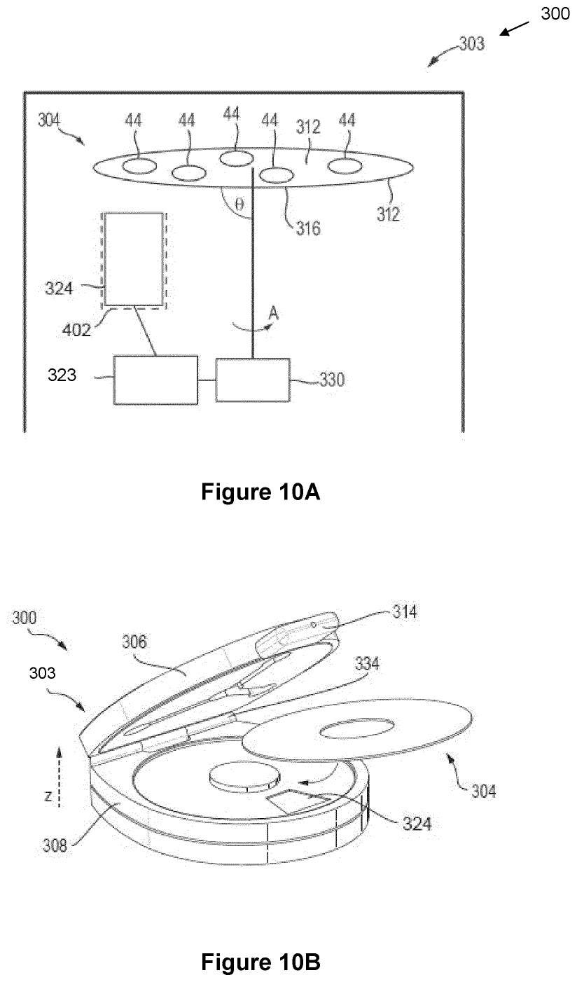

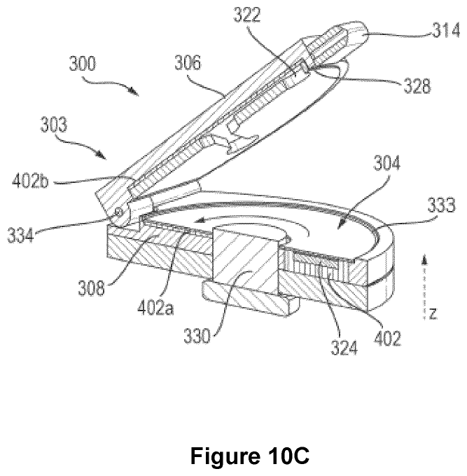

FIG. 10A illustrates a schematic view of a portion of an aerosol provision device 303. The device 303 has an article 304, which comprises aerosol generating medium, within the device 303. The combination of the device 303 and the article 304 form an aerosol provision system 300.

The article 304 has a first surface 312 which includes aerosol generating medium. In the described implementation, the article includes a carrier layer 311 (sometimes referred to herein as a carrier or a substrate supporting layer) which has a first surface on which the aerosol generating medium is disposed. In this implementation, a combination of the surface of the carrier layer 311 and of the aerosol generating material forms the first surface 312 of the article 304. In the described implementation, the aerosol generating medium may be arranged as a plurality of doses 44 of the medium. The article 304 has a second surface 316 which faces the first surface 312. The second surface 316 faces the first surface 312 and one or both of the first surface 312 and second surface 316 may be smooth or rough. In the described implementation, the second surface 316 is formed by the carrier layer 311. That is, the carrier layer 311 has a first surface and a second surface which faces the first surface, where aerosol generating material is disposed on the first surface of the carrier layer 311. The device 303 has a source of energy for supplying induction heating element 324 arranged to face the second surface 316 of the article 304. The source of energy for induction heating element 324 is an element of the aerosol provision device 303 which transfers energy from a power source, such as a battery (not shown), to the aerosol generating medium 44 to generate aerosol from the aerosol generating medium 44. In such implementations, the induction heating element 324 may include one or more inductor coils, which, when energised, causes heating within one or more susceptor elements of the article 304.

Alternatively, in other embodiments, the device 303 may instead comprise one or more resistive heating elements 324 in place of, or in additional to, the above described induction heating element 324.

The device 303 has a movement mechanism 330 arranged to move the article 304, and in particular portions 44 (or, in some cases, doses) of aerosol generating medium. The portions 44 of aerosol generating medium are preferably rotationally movable relative to the induction heating element 324 such that portions of the aerosol generating medium are presented, in this case individually, to the heating element 324. The device 303 is arranged such that at least one dose 44 of the aerosol generating medium is rotated around an axis A at an angle θ to the second surface 316. Control circuitry 323 is configured to actuate both the induction heating element 324 and the movement mechanism 330 such that the article 304 rotates so as to align a discrete portion 44 with the heating element 324. The article 304 in this implementation is substantially flat. The carrier layer 311 of article 304 in this implementation may be formed of partially or entirely of paper or card.

In some implementations, the carrier layer 311 of the substrate may be, or may include, a metallic element that is arranged to be heated by a varying magnetic field.

The degree of heating may be affected by the distance between the metallic element and the induction coil.

The article 304 in FIG. 10A has a number (5) of doses (or portions) 44 of aerosol generating medium. In other examples, the article 304 may have more or less doses 44 of aerosol generating medium. In some examples, the article 304 may have the doses 44 of aerosol generating medium arranged in discrete doses as shown in FIG. 10A.

In other examples, the doses 44 may be in the form of a disc, which may be continuous or discontinuous in the circumferential direction of the article 304. In still other examples, the doses 44 may be in the form of an annulus, a ring or any other shape. The article 304 may or may not have a rotationally symmetrical distribution of doses 44 at the first surface 312 about the axis A. A symmetrical distribution of doses 44 would enable equivalently positioned doses (within the rotationally symmetrical distribution) to receive an equivalent heating profile from the induction heating element 324 upon rotation about the axis A, if desired.

The article 304 of the present example includes aerosol generating medium disposed on the carrier layer 311 of the article 304. However, in other implementations, the article 304 may be formed exclusively of aerosol generating medium; that is, in some implementations, the article 304 consists entirely of aerosol generating medium. In such embodiments, the one or more susceptors will be part of the device 303. Alternatively, the one or more susceptors may be embedded within the aerosol generating medium of article 304, such that article 304 consists only of the aerosol generating medium and the susceptors embedded therein. In yet other implementations, the article 304 may have a layered structure from a plurality of materials. In one example, the article 304 may have a layer formed from at least one of thermally conductive material, inductive material, permeable material or impermeable material.

The arrangement shown in FIG. 10A operates by indexing (or moving) the plurality of doses of aerosol generating material to the induction heating element 324. While this arrangement of FIG. 10A may have a slight increase in the complexity of the movement mechanism 330 to provide movement to the article 304, there are benefits to be had by virtue of there only being one induction heating element 324 required to heat a plurality of portions of aerosol generating medium. For example, the single heating element 324 in the arrangement of FIG. 10A requires only one control mechanism (such as control circuitry 323) rather than a plurality of heaters requiring a plurality of control mechanisms. As such, this arrangement can reduce the cost and control complexity in relation to the operation and control of the heating element 324.

The shape of the device 303 may be cigarette-shape (longer in one dimension than the other two) or may be other shapes. In an example, the device 303 may have a shape that is longer in two dimensions than the other one, for example like a compact-disc player or the like. Alternatively, the shape may be any shape that can suitably house the article 304, source of energy for heating element 324 and the movement mechanism 330.

Other than the single heating element 324 and movement mechanism 330 configured to rotate article 304 of FIG. 10A in place of the plurality of heating elements 224 of FIG. 8A, it will be understood that the device of FIG. 10A may comprise one or more of the other features described in relation to FIG. 8A, e.g., such as the inhalation sensor.

As shown, device 303 may include an insulating member 402, which substantially covers or surrounds the induction heating element 324 except for the side of element 324 facing the article 304 so as to not block or otherwise impede the alternating magnetic field generated by element 324 from heating the one or more susceptors in, or adjacent to, article 304. The insulating member 402 may comprise the polymeric composition described herein. As will be appreciated, one or more of the other components may also be at least partially covered or surrounded by one or more insulating members.

Referring now to FIGS. 10B and 10C, there is shown an aerosol provision device 303 comprising a lid portion 306 and a base portion 308. The aerosol provision device 303 also comprises a securing mechanism (not shown) configured to engage the lid portion 306 with the base portion 308. Once engaged, the lid portion 306 and the bases portion 308 hold in position therebetween, in use, an aerosol generating article 304 so as to prevent relative movement of the aerosol generating article 304.

In some embodiments, the aerosol provision device 302 comprises one or more induction heating elements (for example heating element 324 in FIGS. 10B and 10C). As shown in FIGS. 10B and 10C, the heating element 324 is provided within, or forms part of, the base portion 308.

However, alternatively or in addition to, one or more induction heating elements may be provided in the lid portion 306. Accordingly, the lid portion 306 and the base portion 308 are engaged so as to prevent relative movement of the aerosol generating article along a direction towards or away from the one or more heating elements, for example preventing movement of the article 304 along the z direction (when in use) away or towards the heating element 324 of device 302 as indicated in FIG. 10C. Although only one induction heating element 324 is shown in FIGS. 10B and 10C, it will be understood that more than one induction heating element 324, such as two or three induction heating elements may be provided. The one or more induction heating elements comprise one or more inductor coils for generating a varying magnetic field so as to heat, in use, one or more susceptor elements of an aerosol generating article (such as a metallic foil) held in position by the securing mechanism. As shown in FIG. 10B, the induction heating element 324 may comprise a trapezoidal induction heating element similar to FIG. 9A or 9B.

The one or more induction heating elements 324 define a planar surface, as shown in FIGS. 10B and 10C. Accordingly, in use, the securing mechanism is configured to engage the lid portion 306 with the base portion 308 so as to hold in position parallel to the planar surface a substantially planar aerosol generating article 304 (as shown in FIG. 10C) so as to prevent relative movement of the substantially planar aerosol generating article along a direction substantially perpendicular to the planar surface, such as along the z-direction as shown in FIG. 10C.

As will be understood, the one or more induction heating elements may comprise substantially planar heating elements, such as a flat spiral induction coil. However, in other embodiments, the one or more heating elements 324 may be non-planar but which define a planar surface, such as a conical induction coil wherein the base of the conical coil defines the planar surface.

As shown in FIGS. 10B and 10C, the aerosol provision device 303 comprises a rotating device 330 configured to rotate, about a rotation axis, the aerosol generating article 304 (as indicated in FIG. 10C). The rotation device rotating device 330 is configured to rotate the aerosol generating article 304 relative to the induction heating element so that one or more fresh aerosol generating regions of the aerosol generating article 304 are moved into proximity to the heating element. As will be understood, in embodiments comprising a rotating device 330, the securing mechanism is configured to enable the aerosol generating article 304 to be rotated relative to the heating element whilst preventing relative movement of the aerosol generating article in a direction other than rotation about the rotation axis, such as in the z-direction as indicated in FIG. 10C.

The lid portion 306 may comprise a plenum 322 and a mouthpiece 314. The plenum 322 may comprise the mouthpiece 314. In some embodiments, the mouthpiece 314 and plenum 322 may be integral with the lid portion 306.

The securing mechanism may comprise a hinge 334 such that the lid portion 306 is connected to the base portion 308 through the hinge 334 so as to form a clamshell arrangement. That is, the device 303 may be configured to receive an aerosol generating article 304 when the hinge 334 is in an open position, e.g., as shown going in FIGS. 10B and 10C. The securing mechanism may be configured to engage the lid portion 306 with the base portion 308 so as to hold in position, in use, an aerosol generating article 304 within a receptacle formed by the lid 306 and base 308 portions so as to prevent relative movement of the aerosol generating article when the hinge 334 is in a closed position.

As shown in FIG. 10C, an insulating member 402 may substantially cover the surface of the planar inductor coil 324 facing away from the article 304 in use. The planar inductor coil 324 may partially or fully embedded within the insulating member 402. A further insulation member may be located between the planar inductor coil 324 and the article 304 in use. Other than the specific shape, the insulating member 402 may function in a similar manner as described above in reference to FIGS. 6-8.

In embodiments, the aerosol provision device 303 may additionally or alternatively comprise one or more further insulating members 402a, 402b in the lid portion and/or the base portion configured to thermally isolate the outwards facing surfaces of the lid portion and/or the base portion.

In an embodiment, as shown in FIG. 10C, the lid portion 306 may comprise one or more first gripping elements in the form of protrusion 328 configured to grip one or more second gripping elements in the form of lip 333 provided in the base portion 308. As will be understood, the protrusion 328 and lip 333 may also comprise one or more further insulating members (not shown).

In embodiments, the one or more insulating members described above in relation to FIGS. 6-10 may be provided as a single integral piece.

In embodiments, the one or more insulating members as described above could be located in any number of locations in the device or article so as to provide thermal insulation from heat-generating components of the device or article. As will be understood, heat-generating components may include, but are not limited to: one or more susceptors; one or more inductor coils; one or more resistive heating elements; the battery during charging/discharging; charging components, such as USB ports; other EE components such as the MCU, such as capacitors; one or more wireless charging components; UI components such as LEDs or one or more screens; and/or Bluetooth components.

### Example 1

In the following example the PEEK was PEEK 150G from Victrex® HIGH High Performance Polymers having a melting point of 343° C. (measured by ISO 11357), a glass transition onset temperature of 143° C. (measured by ISO 11357) and a thermal conductivity (measured by ISO 22007-4) of 0.32 W/mK.

The thermally conductive filer was glass bubbles iM16K from 3M™, which are hollow glass spheres formed from soda-lime-borosilicate glass having a density of 0.46 g/cm³ and an average diameter of 20 microns. The thermal conductivity was 0.153 W/mK.

Compared with PEEK, after adding 15 wt. % of the filler (33 vol. %), the thermal conductivity of the polymer decreased by 28% from 0.32 W/mK to 0.23 W/mK and the density decrease from 1.3 g/cm³ to 1.07 g/cm³.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device comprising one or more insulating members, wherein the one or more insulating members comprises a polymeric composition which comprises (i) a polymer and (ii) a filler having a thermal conductivity of about 0.20 W/mK or less.

2. An aerosol provision device according to claim 1, wherein the thermal conductivity of the filler is less than the thermal conductivity of the polymer.

3. An aerosol provision device according to claim 1, wherein the polymer has a thermal conductivity of greater than about 0.20 W/mK.

4. (canceled)

5. (canceled)

6. An aerosol provision device according to claim 1, wherein the polymer is an elastomer, an amorphous thermoplastic polymer or a semi-crystalline thermoplastic.

7. An aerosol provision device according to claim 1, wherein the polymer is selected from the group consisting of polycarbonate (PC), polyethylenimine (PEI), acrylonitrile butadiene styrene (ABS), polystyrene (PS), polyvinyl chloride (PVC), PVC alloys, cyclic olefin copolymer (COC), poly(methyl methacrylate) (PMMA), polypropylene carbonate (PPC), polyether ether ketone (PEEK), polybutylene terephthalate (PBT), polyethylene terephthalate (PET), polyoxymethylene (POM), nylon, polyethylene (PE), polypropylene (PP), thermoplastic polyurethane (TPU), silicone, and combinations thereof.

8. (canceled)

9. (canceled)

10. (canceled)

11. An aerosol provision device according to claim 1, wherein the filler has a thermal conductivity of about 0.05 to about 0.20 W/mK.

12. An aerosol provision device according to claim 1, wherein the filler comprises glass microspheres.

13. An aerosol provision device according to claim 12, wherein the glass microspheres have a median particle size of about 15 to about 65 μm.

14. An aerosol provision device according to claim 1, wherein the filler has a density of less than about 0.65 g/cm³.

15. (canceled)

16. An aerosol provision device according to claim 1, wherein the polymeric composition has a thermal conductivity of less than about 0.4 W/mK.

17. (canceled)

18. (canceled)

19. (canceled)

20. (canceled)

21. An aerosol provision device according to claim 1, wherein the polymeric composition comprises about 10 to about 90 wt. % polymer.

22. (canceled)

23. An aerosol provision device according to claim 1, wherein the polymeric composition comprises about 10 to about 90 wt. % filler.

24. (canceled)

25. An aerosol provision device according to claim 1, further
comprising:
a heating element; and
a receptacle configured to receive aerosol generating material, wherein the aerosol generating material is heatable by the heating element.

26. An aerosol provision device according to claim 25, wherein the heating element comprises an inductor coil configured to heat a susceptor, wherein, in use, the aerosol generating material is heatable by the susceptor.

27. An aerosol provision device according to claim 25, wherein the receptacle is at least partially covered by an insulating member of the one or more insulating members.

28. (canceled)

29. (canceled)

30. (canceled)

31. An aerosol provision device according to claim 25, further comprising:
an insulating member of the one or more insulating members within which the heating element is at least partially embedded.

32. An aerosol provision device according to claim 25, further comprising:
an insulating member of the one or more insulating members at least partially covering the heating element such that the heating element is positioned between said insulating member and the receptacle.

33. An aerosol provision device according to claim 25, further comprising:
a power source configured to supply electrical power to the heating element; and
an insulating member of the one or more insulating members at least partially surrounding the power source.

34. An aerosol provision device according to claim 33, further comprising:
one or more wireless charging components for recharging the power source; and
an insulating member of the one or more insulating members at least partially surrounding the one or more wireless charging components.

35. (canceled)

36. (canceled)

37. (canceled)

38. An aerosol provision system, comprising:
an aerosol provision device according to claim 1; and
an article comprising aerosol generating material.
